(19) United States
(12) Patent Application Publication
(10) Pub. No.: US 2025/0388806 A1
(43) Pub. Date: Dec. 25, 2025

(54) TIME DEPENDENT TRACER RELEASE IN STIMULATED GAS WELLS USING PARTIALLY DEGRADABLE PARTICULATES

(71) Applicant: SAUDI ARABIAN OIL COMPANY, Dhahran (SA)

(72) Inventors: Ayrat GIZZATOV, Winchester, MA (US); Shitong Sherry ZHU, Waban, MA (US); Amy J. CAIRNS, Houston, TX (US); Rajesh Kumar SAINI, Cypress, TX (US); Mohammed SAYED, Katy, TX (US); Wei WANG, Quincy, MA (US)

(73) Assignees: SAUDI ARABIAN OIL COMPANY, Dhahran (SA); ARAMCO SERVICES COMPANY, Houston, TX (US)

(21) Appl. No.: 18/749,660

(22) Filed: Jun. 21, 2024

(51) Int. Cl. C09K 8/88; E21B 47/11

(52) U.S. Cl. CPC C09K 8/88; E21B 47/11

(57) ABSTRACT

At least two polymer composite particles each having a degradable polymer and a tracer are introduced into a stimulation fluid, where the tracer has an average particle size ranging from 100 nm to 300 microns; the stimulation fluid is injected with the at least two polymer composite particles into a treatment zone including one opening, where the at least two polymer composite particles flow into and remain inside the opening; the at least two polymer composite particles are maintained inside the opening for an amount of time during which the at least two polymer composite particles are exposed to moisture at a downhole temperature, where the moisture degrades the degradable polymer of the at least two polymer composite particles at different rates, thereby releasing the tracer at different times; produced gas is recovered; a presence of the tracer is determined; and the presence of the tracer is correlated to the treatment zone.

### BACKGROUND

In the oil and gas industry, tracers are used for monitoring, mapping, and confirming the presence of hydrocarbons in place as well as the production of hydrocarbons from various zones of interest in a reservoir. For example, tracers are used for applications such as waterflood optimization, remaining oil saturation determination, fluid pathway identification, and inter-well connectivity determination. Nonetheless, tracer technology for produced gas monitoring is limited, especially after acidizing and fracturing jobs. Currently, special tools can be installed downhole to monitor gas production, however these tools are expensive and often provide signals that overlap with existing chemicals in the reservoir, making gas monitoring less accurate.

Volatile organic compounds produced from the subterranean formation contain trace amounts of a large spectrum of chemicals containing a wide range of functional groups. Accordingly, the use of chemical gas tracers is a challenge, and the state-of-the-art chemical tracers are based on expensive and/or toxic fluorinated or deuterated gaseous molecules that are not found naturally in the environment. Additionally, such tracers are present in the produced gas in trace amounts, making unambiguous detection and analysis difficult. As such, there exists a need for the development of cost-effective, environmentally friendly chemical tracers that may readily pinpoint gas production from a given zone in a reservoir in the oil and gas industry.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method for monitoring gas production in a subterranean formation. The method may include introducing at least two polymer composite particles each having a degradable polymer and a tracer into a stimulation fluid, where the tracer has an average particle size ranging from 100 nm to 300 microns; injecting the stimulation fluid comprising the at least two polymer composite particles into the subterranean formation to a treatment stage of a treatment zone including at least one opening, where the at least two polymer composite particles flow into and remain inside the at least one opening; maintaining the at least two polymer composite particles inside the at least one opening for an amount of time during which the at least two polymer composite particles are exposed to moisture at a downhole temperature, where the moisture degrades the degradable polymer of the at least two polymer composite particles at different rates, thereby releasing the tracer at different times; recovering produced gas from the subterranean formation, where the produced gas comprises a gaseous phase from the treatment stage of the treatment zone of the subterranean formation and the tracer; determining a presence of the tracer in the produced gas; and correlating the presence of the tracer to the treatment stage of the treatment zone of the subterranean formation.

In another aspect, embodiments disclosed herein relate to a composition including at least two polymer composite particles. The at least two polymer composite particles may each include a degradable polymer and a tracer.

Other aspects and advantages of the claimed subject matter will be apparent from the following description and the appended claims.

### BRIEF DESCRIPTION OF DRAWINGS

FIG. 1 is a schematic of a polymer composite particle, in accordance with one or more embodiments.

FIG. 2 is a schematic of a subterranean formation with at least two polymer composite particles, in accordance with one or more embodiments.

FIG. 3 is a schematic of a treatment stage with at least two polymer composite particles, in accordance with one or more embodiments.

FIG. 4 is images of four polymer composite particles after heating at 150° C. in at least 98% humidity for 1 to 19 days, in accordance with one or more embodiments.

FIG. 5 is images of five polymer composite particles after heating at 150° C. in at least 98% humidity for 1 to 10 days, in accordance with one or more embodiments.

FIG. 6 is an image of five polymer composite particles in the water phase after exposure at room temperature for a few weeks, in accordance with one or more embodiments.

FIG. 7 is an image of five polymer composite particles crushed after exposing to 150° C. and at least 98% RH for 10 days, then to water and diesel separately at room temperature for over few weeks, in accordance with one or more embodiments.

### DETAILED DESCRIPTION

The present disclosure relates to compositions and methods for monitoring gas production from various zones of interest in a subterranean formation. Disclosed compositions include at least two polymer composite particles each having a degradable polymer and a tracer. The tracer may be dispersed in the degradable polymer. Methods disclosed herein may include injecting polymer composite particles into a subterranean formation with a stimulation fluid or after a stimulation fluid. Within the formation, the polymer composite particles may flow into and reside inside fractures, where, over time, the degradable polymer may degrade, releasing the tracer. The tracer may travel to the surface with the produced gas. Produced gas from the subterranean formation may be monitored for the presence of the tracer. As such, compositions and methods in accordance with the present disclosure may provide accurate monitoring of gas production in subterranean formations.

### Polymer Composite Particle Composition

In one aspect, embodiments disclosed herein relate to compositions including at least two polymer composite particles and a stimulation fluid. Polymer composite particles in accordance with the present disclosure each include a degradable polymer and a tracer. The degradable polymer may be different for each of the at least two polymer composite particles. In one or more embodiments, the different degradable polymers lead to different rates of degradation and different times of release of the tracer.

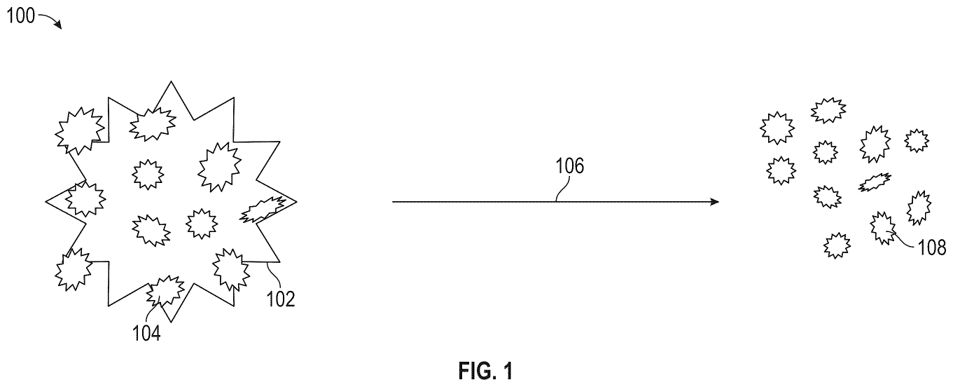

FIG. 1 is a schematic of a polymer composite particle 100, in accordance with one or more embodiments. The polymer composite particle 100 includes a degradable polymer 102. The degradable polymer 102 may be a homopolymer or a copolymer. Each polymer composite particle may include a different polymer. For example, a first degradable polymer may be included in a first polymer composite particle. A second degradable polymer that is different from the first polymer may be included in a second polymer composite particle. As such, each polymer composite particle may have a different degradable polymer.

Herein, a degradable polymer 102 refers to a homopolymer or copolymer that has hydrolysable bonds in the backbone, and as such, may be hydrolyzed into monomers and/or oligomers in the presence of water and heat. Suitable degradable polymers include, but are not limited to, polyesters, polyester copolymers, polyamides, polyamide copolymers, polyurethanes, polyurethane copolymers, and combinations thereof. Copolymers may include two variations of the same type of polymer, or two different polymers. For example, a polyester copolymer may be a copolymer of polyester and modified polyester or a copolymer of polyester and polyurethane. For example, the degradable polymer of one or more embodiments may be a polyamide such as nylon, kevlar, nomax, polyamide-imides, and polyphthalamide; a polyester such as polylactic acid, polyglycolic acid, polycaprolactone, polyarylates, polyethylene phthalate, polyethylene terephthalate, polybutylene terephthalate, polytrimethylene terephthalate and polyethylene naphthalate; and combinations thereof. In some embodiments, a water-soluble polymer may be used instead of a degradable polymer 102. A water-soluble polymer is a polymer that may not actually chemically degrade via hydrolysable bonds, but rather it readily dissolves in water and may achieve a similar result downhole as a degradable polymer. Such water-soluble polymers include polyvinyl alcohols, polyvinyl alcohol copolymers, and modified polyvinyl alcohols. In certain embodiments, the degradable polymer may be a biodegradable polymer, i.e., a polymer that is deteriorated or degraded by a bacterial decomposition process into byproducts such as gases, water, biomass, and inorganic salts. For example, suitable degradable polymers may be polysaccharides, cellulose, starches, Nichigo G-polymers from Mitsubishi Chemical, among others.

In one or more embodiments, the degradable polymer 102 is a semicrystalline polymer. The semicrystalline polymer may include both amorphous and crystalline domains. Amorphous domains do not have any long range crystalline order. In contrast, crystalline domains have ordered zones of aligned polymer chains that create a crystalline structure. The crystalline domains are generally not degradable on the timescales described herein. Water may not be able to come in contact with crystalline domains due to the ordered alignment of the polymer chains, thus limiting the degradation. As noted above, other domains of the semicrystalline polymer may be amorphous. The amorphous domains of the semicrystalline polymer may be readily degradable. Examples of semicrystalline polymers may include polyesters, polyester copolymers, thermoplastic polyurethane (TPU), thermoplastic elastomers (TPE), and combinations thereof.

In one or more embodiments, polymer composite particles may each include a different degradable polymer 102 based on the desired rate of degradation. For example, a first degradable polymer with a first rate of degradation may be included in a first polymer composite particle. A second degradable polymer with a second rate of degradation may then be included in a second polymer composite particle. The two different polymers may be therefore chosen to achieve two different degradation rates (i.e., a different degradation rate for each composite particle), thereby enabling the detection of the tracers at different times for gas monitoring. The rate of degradation depends on the rate of hydrolysis or dissolution in the degradable polymer 102. For example, the rate of hydrolysis for specific degradable polymers may follow the trend of decreasing rate such that anhydride polymer>ester polymer>>amide polymer>>>ether polymer. In one or more embodiments, a polymer composite particle made of a copolymer of polylactic acid and polyester degrades in less than 1 day. In other embodiments, a polymer composite particle made of a polyester thermoplastic polyurethane or a poly(butylene terephthalate) thermoplastic elastomer degrades in 2 days. In other embodiments, a polymer composite particle made of a polyamide polymer degrades in 6 days. In further embodiments, a polymer composite particle made of a polyamide polymer degrades in 8 to 10 days. A higher concentration of amide end groups in the polyamide polymer may lead to a longer degradation time.

In one or more embodiments, the degradable polymer 102 may be included in the at least two polymer composite particles each in an amount ranging from 20 to 95 wt % (weight percent) based on the total weight of the polymer composite particle. For example, the at least two polymer composite particles may each include the degradable polymer 102 in an amount having a lower limit of any of 20, 25, 30, 35, 40, 45, 50, 55, and 60 wt % and an upper limit of any of 50, 55, 60, 65, 70, 75, 80, 85, 90, and 95 wt %, where any lower limit may be paired with any mathematically compatible upper limit.

In one or more embodiments, the polymer composite particle 100 contains a tracer 104. In one or more embodiments, the tracer 104 is non-degradable. The tracer 104 may be dispersed throughout a degradable polymer 102. Degradation 106 of the degradable polymer 102 may release an aerosolized tracer 108. The aerosolized tracer may be released from the degradable polymer 102 based on the rate of degradation as described above. As the tracer 104 is released based on the rate of degradation of the degradable polymer 102, at least two times of release may occur. For example, a first tracer may be released at a first time due to the degradation of a first degradable polymer. A second tracer may then be released at a second time that is later than the first time due to the degradation of a second degradable polymer. Therefore, the tracer 104 may be released at different times based on the rate of degradation of the degradable polymer 102. In one or more embodiments, the tracer 104 is released from at least one degradable polymer in a range of 1 day, 2 days, 6 days, and 8 to 10 days. As each polymer composite particle is described to have a different degradable polymer, the tracer 104 may be released over multiple days within the range of 1 day, 2 days, 6 days, and 8 to 10 days. The same tracer 104 may be contained in each of the at least two polymer composite particles, or a different tracer 104 may be contained in each of the at least two polymer composite particles.

The tracer 104 may be metals, metal oxides, or metal hydroxides. Examples may include ZnO, Fe₂O₃, Co₂O₃, Ni₂O₃, Cr₂O₃, CuO, MnOₓ, ZrO₂, TiO₂, or sulfides including ZnS, Ce₂S₃, and any combinations thereof. Examples of the dyes may include tetrachloroisoindolinone orange, perylene red, quinacridone red, phthalocyanine blue, phthalocyanine green, disazo diarylide yellows, among others.

In one or more embodiments, the tracer 104 may be present in the at least two polymer composite particles in an amount each ranging from 0.0005 to 50 wt % based on the total weight of the polymer composite particle composition. For example, the at least two polymer composite particle compositions may each include a tracer 104 in an amount having a lower limit of any of 0.0005, 0.001, 0.002, 0.005, 0.01, 0.02, 0.03, 0.04, 0.05, and 0.1 wt % and an upper limit of any of 0.1, 0.5, 1.0, 5.0, 10, 15, 20, 25, 30, 35, 40, 45, and 50 wt %, where any lower limit may be paired with any mathematically compatible upper limit.

In one or more embodiments, the tracer 104 is of a size that allows for forming an aerosol. In such embodiments, the tracer 104 may have an average particle diameter ranging from about 100 nm to 300 microns. For example, the tracer may have an average diameter ranging from a lower limit of any of 100, 200, 400, 500, 600, 700, 800, 900 and 1,000 nm to an upper limit of any of 120, 150, 175, 200, 225, 250, 275, and 300 microns, where any lower limit may be paired with any mathematically compatible upper limit.

As described above, the tracer 104 may be mixed with a degradable polymer 102 to provide a polymer composite particle 100 in accordance with the present disclosure. As such, polymer composite particles may be significantly larger than the tracer 104. Polymer composite particles may have an average particle size ranging from 10 microns to 10 mm (millimeters). In one or more embodiments, polymer composite particles may have an average particle size having a lower limit of any of 10, 20, 30, 40, 50, 60, 70, 80, 90, and 100 microns to an upper limit of any of 1, 2, 3, 4, 5, 6, 7, 8, 9, and 10 mm (millimeters), where any lower limit may be paired with any mathematically compatible upper limit.

The at least two polymer composite particles in accordance with the present disclosure may be designed to have properties that enable the at least two polymer composite particles to flow into and remain inside openings in the rock matrix of a subterranean formation. Such properties include size, as described above, aspect ratio, and physical structure, among others. The at least two polymer composite particles may each have an aspect ratio ranging from 1 to 500. For example, the at least two polymer composite particles in one or more embodiments may each have an aspect ratio having a lower limit of any of 1, 2, 5, 8, 10, 15, 20, 25, 40, 50, 75, and 100 and an upper limit of any of 75, 100, 150, 200, 250, 300, 350, 400, 450, and 500, where any lower limit may be paired with any mathematically compatible upper limit. The at least two polymer composite particles having an aspect ratio above 100 may have a shape similar to a fiber, whereas the at least two polymer composite particles having an aspect ratio below 50 may have a shape similar to a sphere. In one or more embodiments, the at least two polymer composite particles having an aspect ratio greater than 500 may be capable of bridging the wormholes/fractures in the formation. Herein, “bridging” refers to the ability of a particle to lodge inside a wormhole/fracture of the subterranean formation, such that it may remain in place until the degradable polymer degrades, thus releasing the tracer. Such “bridging” of a wormhole/fracture may be important to achieving the desired time-release of the tracers. Furthermore, the physical structure of the at least two polymer composite particles is an important property in compositions of the present disclosure. Polymer composite particles having a large particle size distribution (i.e., a mixture of particles with different sizes) may be suitable for remaining inside the wormholes/fractures of a subterranean formation. For example, particles having different diameters may pack into wormholes/fractures more efficiently given that the wormholes/fractures are not of uniform size from start to finish. As such, a greater concentration of particles may be spread across an entire wormhole or fracture.

### Method for Preparing Polymer Composite Particles

One or more embodiments of the present disclosure relate to a method for preparing the previously described polymer composite particle composition. The method may first include dispersing a first tracer in a first degradable polymer matrix to provide a first polymer composite. The method may then include dispersing a second tracer in a second degradable polymer matrix to provide a second polymer composite. The tracer may be appropriately chosen based upon the polymer composite particle that is being made and is as previously described. The polymer matrix may be chosen based on the rate of degradation and is as previously described.

In one or more embodiments, the polymer matrix includes a semicrystalline polymer. The semicrystalline polymer may include crystalline and amorphous domains. The semicrystalline polymer may be commercially available. Commercial products may include Hyrel® (DuPont) and Estane® TPU (Lubrizol).

Dispersing the first tracer into the first polymer matrix may include compounding the first tracer into the first polymer matrix. Compounding may include softening the first polymer matrix. Compounding temperatures may be in a range from 150° C. to 260° C.

Dispersing the second tracer into the second polymer matrix may include compounding the second tracer into the second polymer matrix. Compounding may include softening the second polymer matrix. Compounding temperatures may be in a range from 150° C. to 260° C.

According to this preparation method, the first and second tracer may be dispersed inside a first and second degradable polymer to form a first and second polymer composite particle. Each polymer composite particle included in the stimulation fluid may include a different degradable polymer matrix. The first and second polymer composite particles may then be introduced into a stimulation fluid.

### Stimulation Fluid Composition

At least two polymer composite particles, as previously described, may be added to a stimulation fluid to provide a stimulation fluid composition. The disclosed polymer composite particles may be suitable for use in any stimulation fluid. In one or more embodiments, the stimulation fluid is an acidizing fluid, an organic acid, a fracturing fluid, a hydraulic fracturing fluid, an emulsified acid, a viscoelastic surfactant, a foamed fluid, a linear gel, and a crosslinked gel, among others. In one or more embodiments, at least two polymer composite particles including at least two different degradable polymers are added to acidizing fluid or hydraulic fracturing fluid.

One or more embodiments of the stimulation fluid include an aqueous-based fluid. The aqueous-based fluid includes water. The water may be distilled water, deionized water, tap water, fresh water from surface or subsurface sources, production water, formation water, natural and synthetic brines, brackish water, natural and synthetic sea water, black water, brown water, gray water, blue water, potable water, non-potable water, other waters, and combinations thereof, that are suitable for use in a wellbore environment. In one or more embodiments, the water used may naturally contain contaminants, such as salts, ions, minerals, organics, and combinations thereof, as long as the contaminants do not interfere with the operation of the stimulation fluid.

In one or more embodiments, the stimulation fluid may contain water in a range of from about 50 wt % to 97 wt % based on the total weight of the stimulation fluid. In one or more embodiments, the stimulation fluid may comprise greater than 70 wt % water based on the total weight of the stimulation fluid.

In some embodiments, the stimulation fluid may incorporate an acid in the aqueous-base fluid. The acid may be an inorganic acid, an organic acid, or both. The inorganic acid may include, but are not limited to, hydrochloric acid, nitric acid, hydrofluoric acid, hydrobromic acid, perchloric acid, hydroiodic acid, fluoroboric acid, or derivatives, and mixtures thereof. Suitable organic acids include, but are not limited to, alkanesulfonic acids, arylsulfonic acids, formic acid, acetic acid, methanesulfonic acid, p-toluenesulfonic acid, alkyl carboxylic acids, aryl carboxylic acids, lactic acid, glycolic acid, malonic acid, fumaric acid, citric acid, tartaric acid, chloroacetic acid, dichloroacetic acid, trichloroacetic acid, fluoroacetic acid, difluoroacetic acid, trifluoroacetic acid, glutamic acid diacetic acid, methylglycindiacetic acid, 4,5-imidazoledicarboxylic acid, and combinations thereof. Acid-generating systems may include esters and/or formates that are water soluble or partially water soluble. Suitable acid-generating compounds may include esters, aliphatic polyesters, orthoesters, poly(orthoesters), poly(lactides), poly(glycolides), poly(ε-caprolactones), poly(hydroxybutyrates), poly(anhydrides), ethylene glycol monoformate, ethylene glycol diformate, diethylene glycol diformate, glyceryl monoformate, glyceryl diformate, glyceryl triformate, triethylene glycol diformate, formate esters of pentaerythritol, and combinations thereof. Exemplary acid-generating compounds include lactic acid derivatives, methyl lactate, ethyl lactate, propyl lactate, and butyl lactate. In some embodiments, the acid-generating compound is a formate ester including, but not limited to, ethylene glycol monoformate, ethylene glycol diformate, diethylene glycol diformate, glyceryl monoformate, glyceryl diformate, glyceryl triformate, triethylene glycol diformate, and formate esters of pentaerythritol. In certain embodiments, the acid-generating compound is ethylene glycol monoformate or diethylene glycol diformate. In some embodiments, the acid-generating compound is a nitrile-containing compound. In some embodiments, the acid-generating compound is an ester, for instance, polyesters of glycerol including, but not limited to, tripropionin (a triester of propionic acid and glycerol), trilactin, and esters of acetic acid and glycerol such as monoacetin, diacetin, and triacetin. Other suitable esters include aliphatic polyesters, poly(lactides), poly(glycolides, poly(E-caprolactones), poly(hydroxybutyrates), poly(anhydrides), aliphatic polycarbonates, poly(amino acids), and polyphosphazenes, or copolymers thereof, or derivatives and combinations thereof. These acid-producing systems may provide the corresponding acids when hydrolyzed in the presence of water.

The acid may be present in an aqueous-based fluid at a concentration ranging from about 5 wt % to about 35 wt %. For example, the aqueous-base fluid may have an acid in an amount having a lower limit of any of 5, 7, 10, 12, 15, and 20 wt % and an upper limit of any of 15, 20, 22, 25, 27, 30, 32, and 35 wt %, where any lower limit may be paired with any mathematically compatible upper limit. In one or more embodiments, the stimulation fluid is an acidizing fluid including about 28 wt % of hydrochloric acid.

In one or more embodiments, the stimulation fluid includes a suitable amount of at least two polymer composite particles. The amount of the at least two polymer composite particles may be adjusted depending on the type of tracer included in the polymer composite particles. The amount of the at least two polymer composite particles may also be adjusted depending on the type of degradable polymer included in the polymer composite particles. In one or more embodiments, the stimulation fluid may include from 0.2 to 10 lbm/gal (pound-mass per thousand gallon) of the polymer composite particles relative to the total amount of stimulation fluid. For example, the stimulation fluid may include polymer composite particles in an amount having a lower limit of any of 0.2, 0.3, 0.5, 1.0, 1.5, 2.0, 2.5, 3.0, 3.5, 4.0, and 4.5 lbm/gal and an upper limit of any of 5.0, 5.5, 6.0, 6.5, 7.0, 7.5, 8.0, 8.5, 9.0, 9.5, and 10 lbm/gal, where any lower limit may be paired with any mathematically compatible upper limit.

In one or more embodiments, when the stimulation fluid is a hydraulic fracturing fluid, the hydraulic fracturing fluid includes a proppant. Proppants are often included in stimulation fluids to help keep fractures open and capable of supporting the flow of hydrocarbons from a subterranean formation to a wellbore. Such proppants may include gravel, sand, bauxite, or glass beads. Any type of proppant may be added to the stimulation fluid. Suitable proppants may have a size ranging from 200 to 8 mesh. In some embodiments, the proppant may be coated with the polymer composite particle. In other embodiments, the proppant may be mixed with the at least two polymer composite particles to provide a proppant/particle mixture that includes the polymer composite particles in an amount ranging from 1.0 to 100 wt %, relative to the weight of the proppant. In such a proppant/particle mixture, the polymer composite particles may be present in an amount having a lower limit of any of 1.0, 1.5, 2.0, 2.5, 3.0, 3.5, 4.0, 4.5, and 5.0 wt % and an upper limit of any of 10, 20, 30, 40, 50, 60, 70, 80, 90, and 100 wt %, where any lower limit may be paired with any mathematically compatible upper limit.

In one or more embodiments, the stimulation fluid may optionally include additional additives. Examples of such additional additives may include, but are not limited to, emulsifiers, friction reducers, fibers, oxidizing agents, lost circulation materials, scale inhibitors, surfactants, clay stabilizers, corrosion inhibitors, paraffin inhibitors, asphaltene inhibitors, penetrating agents, clay control additives, iron control additives, reducers, oxygen scavengers, sulfide scavengers, foamers, gases, derivatives thereof, and combinations thereof.

### Method for Monitoring Gas Production

In another aspect, embodiments disclosed herein relate to a method for monitoring gas production of a subterranean formation using the previously described at least two polymer composite particle compositions. In one or more embodiments, the method includes the use of at least two polymer composite particles containing at least two different degradable polymers.

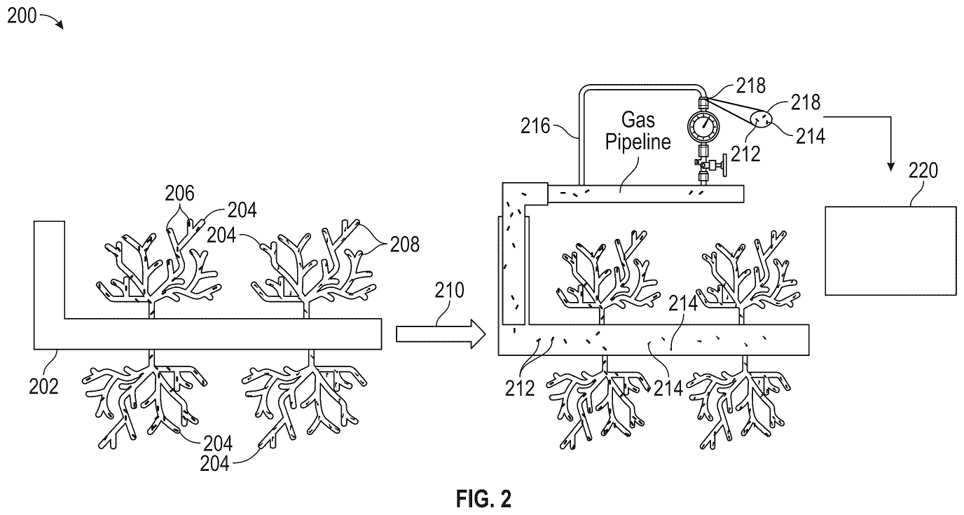

FIG. 2 is a schematic of a subterranean formation 200 with at least two polymer composite particles, in accordance with one or more embodiments. FIG. 2 shows a pipeline 202 and a plurality of treatment zones 204. The previously described stimulation fluid composition including a first polymer composite particle 206 and a second polymer composite particle 208 may be introduced into one of the plurality of treatment zones 204. The composition of the first and second polymer composite particle is as previously described. As noted above, the at least two polymer composite particles may become lodged in the openings of the plurality of treatment zones 204. Hydrocarbon-bearing formations may include any oleaginous fluid, such as crude oil, dry gas, wet gas, gas condensates, light hydrocarbon liquids, tars, and asphalts, and other hydrocarbon materials. Hydrocarbon-bearing formations may also include aqueous fluid, such as water and brines. Embodiment polymer composite particle compositions may be appropriate for use in different types of subterranean formations, such as carbonate, dolomite, shale, sandstone and tar sands.

In the treatment zone, there may be multiple treatment stages. The stimulation fluid may be injected into a specific treatment stage of the treatment zone. Upon injection into the treatment stage of the treatment zone, the stimulation fluid may induce the development of small fractures/wormholes in the subterranean formation 200. The at least two polymer composite particles may flow into the formed fractures/wormholes with the stimulation fluid and subsequently remain inside the formed fracture/wormholes once the stimulation fluid has been depleted. The at least two polymer composite particles may be tailored to have properties, such as morphology/shape, size, and aspect ratio, that provide for the “trapping” of the at least two polymer composite particles in the fractures/wormholes of the subterranean formation.

After maintaining the first and second polymer composite particles in the fractures/wormholes of the subterranean formation at the treatment stage for an amount of time, the first and second polymer composite particles may be exposed to moisture from the reservoir. Upon exposure to moisture at an elevated downhole temperature, the hydrolysable bonds of each of the degradable polymers may be hydrolyzed, and the degradable portion may begin to degrade 210. Alternatively, if the degradable polymer is a water-soluble polymer, the polymer may be dissolved in the moisture at the elevated downhole temperature. Depending on the moisture content and the downhole temperature of the treatment zone, degradation of the degradable polymer of the first and second polymer composite particles may occur in a range of from one day to ten days as described above. The treatment zone may have a downhole temperature ranging from 70° C. to 150° C. Depending on the type of degradable polymer, degradation of each of the at least two polymer composite particles may take 1 day, 2 days, 6 days, or 8 to 10 days, where any combination of days is possible by the combination of different polymer composite particles including different degradable polymers. Degradation (indicated by arrow 210) of the polymers in the first and second polymer composite particles during gas production in the subterranean formation 200 may produce aerosolized tracers. The degradation 210 of the degradable polymer in the first and second polymer composite particle may occur at different rates, which may release the tracers at different times. Depending on the type of degradable polymer, release of each of the tracers may take 1 day, 2 days, 6 days, or 8 to 10 days, where any combination of days is possible by the combination of different polymer composite particles including different degradable polymers. The first polymer composite particle 206 may degrade to release an aerosolized first tracer 212. The second polymer composite particle 208 may degrade to release an aerosolized second tracer 214. The tracer may be selected based on size and composition so that it may be carried to the surface of the subterranean formation 200 with a gaseous phase.

In one or more embodiments, degradation of the polymers in the first and second polymer composite particles may include degradation of amorphous domains of a semicrystalline polymer. The semicrystalline polymer may further include crystalline domains. The tracer may be dispersed in both the crystalline domains and the amorphous domains of the semicrystalline polymer. Upon exposure to moisture at an elevated downhole temperature, the hydrolysable bonds in the amorphous domains of the semicrystalline polymer may be hydrolyzed, and the degradable portion may begin to degrade, releasing an aerosolized tracer. The crystalline domains of the semicrystalline polymer may remain. Depending on the moisture content and the downhole temperature of the treatment zone, degradation of the amorphous domains of the semicrystalline polymer may occur over a range of one to three days. The treatment zone may have a downhole temperature ranging from 70° C. to 150° C.

Recovering the produced gas from the subterranean formation 200 may occur where the produced gas contains the gaseous phase including the first and second tracers. A capture line 216 may be used to direct the first and second aerosolized tracers to the surface. At the surface, the first and second tracer may be collected, analyzed, and correlated to the treatment stage of the plurality of treatment zones 204 in the subterranean formation 200. The capture line 216 may include a gas-permeable membrane filter 218 to collect the first and second aerosolized tracers. The tracer may be collected via any device known in the art such as an environmental air sampler or a gas-permeable membrane filter 218.

Once collected, an instrument 220 may be used for determining the presence of the first and second aerosolized tracers. Any method suitable for analysis of the tracers may be used to analyze the tracers including, but not limited to, fluorescence spectroscopy, microscopy, UV-Vis spectroscopy, FTIR spectroscopy, Raman spectroscopy, X-ray fluorescence, inductively coupled plasma optical emission spectroscopy (ICP-OES), inductively coupled plasma mass spectrometry (ICP-MS), and optical imaging. The results of the analysis may be used for correlating which stage or zone is producing gas with respect to a period of time after a stimulation operation.

As described above, a given treatment zone of a subterranean formation may have multiple treatment stages. Likewise, a given subterranean formation may have multiple treatment zones. In some embodiments, a formation may have anywhere from two to 50 treatment zones. Accordingly, stimulation fluids including distinct polymer composite particles may be injected into different treatment stages of a treatment zone, and different treatment zones of a subterranean formation. For example, in one or more embodiments, methods may include injecting a first stimulation fluid including at least two polymer composite particles into a first treatment stage of a treatment zone. Then, a second stimulation fluid including at least two polymer composite particles may be injected into a second treatment stage of the treatment zone. The number of different stimulation fluids including distinct polymer composite particles that may be injected into the same treatment zone or the same subterranean formation is not particularly limited. In some embodiments, up to 20 different stimulation fluids including distinct polymer composite particles may be injected in up to 20 different treatment stages of a treatment zone. In methods in which multiple different polymer composite particles are injected and remain inside fractures/wormholes of multiple different treatment stages, the produced gas may include one or more tracers from the different polymer composite particles. Each polymer composite particle included in the stimulation fluid may include a different degradable polymer. Depending on the type of degradable polymer in the polymer composite particle, release of each of the tracers may take 1 day, 2 days, 6 days, or 8 to 10 days, where any combination of days is possible by the combination of different polymer composite particles including different degradable polymers. Such methods may provide more accurate gas production monitoring as the origin of produced gas over a period of time may be more readily determined.

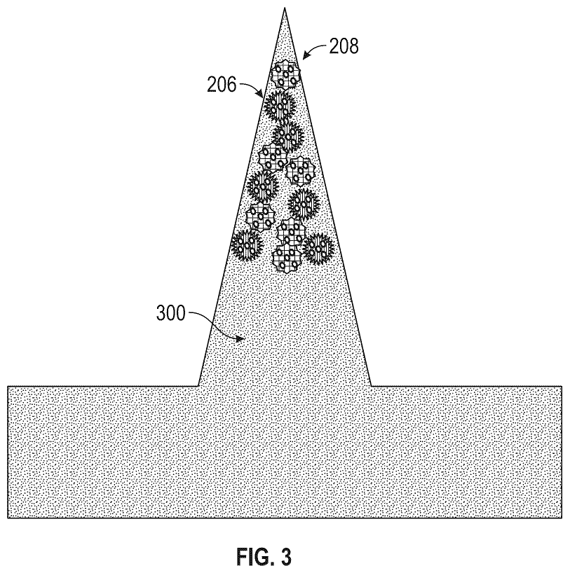

FIG. 3 is a schematic of a treatment stage with at least two polymer composite particles, in accordance with one or more embodiments. The treatment stage 300 includes a first polymer composite particle 206. The treatment stage 300 also includes a second polymer composite particle 208. The first and second polymer composite particles each contain a degradable polymer and a tracer. As described above, the degradation of the degradable polymer in the first and second polymer composite particle may occur at different rates, which may release the tracers at different times.

Embodiments of the present disclosure may provide at least one of the following advantages. Use of the disclosed polymer composite particles in methods herein may provide for the confirmation of gas production from stimulated zones of a formation over, according to various stimulated stage or stages based on the chemical fingerprint of the tracer at the surface. Additionally, polymer composite particles of one or more embodiments may offer monitoring of gas production over a controlled period of time, where the choice of degradable polymer in the polymer composite particle may lead to release of the tracer in 1 day, in 2 days, in 6 days, or in 8 to 10 days. Using a combination of polymer composite particles allows for a variety of time periods to be monitored.

### EXAMPLES

Polymers matrices with hydrolysable groups were selected for characterization where a set of these most common polymers is shown below.

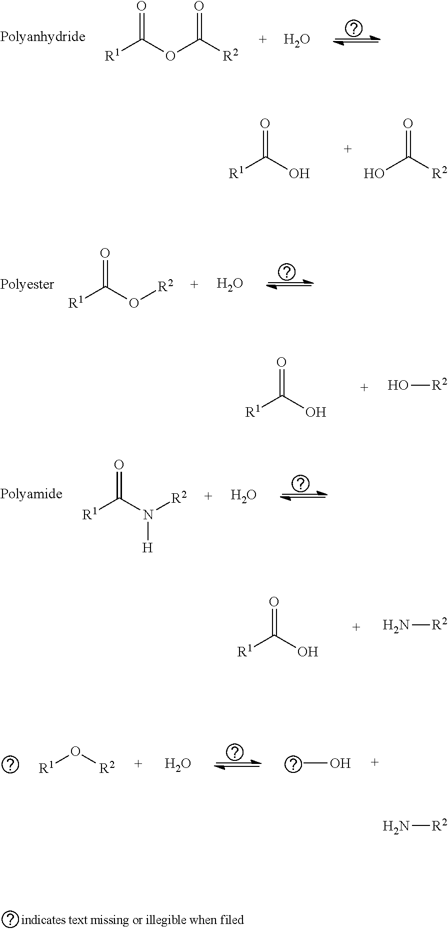

Hydrolysable functional groups with different hydrolysis rates decrease in the following order anhydride>ester>>amide>>>ether, assuming that R groups are similar.

A variety of commercially available samples (Table 1, below) were procured. Polymer samples listed in Table 1 (below) were tested at 150° C. and at least 98% relative humidity (RH) by placing the sample into a pressure vessel, while avoiding direct contact between the water and sample. A water amount of 5 mL was added to the pressure vessel prior to placing the polymer samples in individual glass vials. Samples were then aged and monitored for degradation. Initially, the elastic polymer beads became rigid and fell apart with applied pressure due to the hydrolyzed amorphous phase of the polymer. While all the samples eventually hydrolyze, it can be observed that Hytrel Specialty and Hytrel 5556 form a paste structure after aging for over 12 days. Formation of such a viscous product upon absorption of the water is undesirable at reservoir conditions and therefore these two samples would not be appropriate for tested applications. As it can be seen in Table 1, the presence of certain functional groups could either prolong or shorten the degradation time of the polymer.

TABLE 1
List of the commercial polymers tested in this work including supplier
and contact names. The ones in bold are suitable for applications
in gas tracers based on the initial laboratory test results.

| Commercial | | | |
|---|---|---|---|
| Manufacturer | Trade Name | Type | Results |
| APS Elastomers | Zythane ® 1126K | Polyesther TPU | not useful |
| APS Elastomers | Zythane ® 3090A | polycaprolactone TPU | not useful |
| APS Elastomers | Zythane ® 4070D | polyester TPU (hardest) | degrades into |
| | | | particulates |
| | | | after one day |
| Huntsman | 80A | Polyether TPU | not useful |
| Huntsman | 85A | Polyether TPU | not useful |
| Huntsman | 90A | Polyether TPU | not useful |
| RTP Company | Ultra TPU 90A | Polyether TPU | not useful |
| RTP Company | Ultra TPU 85A | Polyether TPU | not useful |
| RTP Company | Ultra TPU 95A | Polyether TPU | not useful |
| BASF | Elastollan 1185A10 | Polyether TPU | not useful |
| Lubrizol | Estane 2102-75A NAT | Polycap Aromatic TPU | not useful |
| Lubrizol | Pearlcoat DIPP 119 | Polycap Aromatic TPU | not useful |
| Lubrizol | Estane WS90A 87A | Polycap Aromatic TPU | not useful |
| DuPont | Hytrel HTR 8801 etc. | PBT TPE specialty | sticky |
| | | | (hydrolysis |
| | | | resistant) |
| DuPont | Hytrel 7246 | PBT TPE | powder after |
| | | | one day |
| DuPont | Hytrel 5556 | PBT TPE | sticky |
| Ascend Performance | 21ZNT 01A2 | Nylons (polyamides) | powder after |
| Materials | | | 1 week |
| Ascend Performance | 21 LS | Nylons (polyamides) | powder after |
| Materials | | | 1 week |
| Ascend Performance | 50 BW | Nylons (polyamides) | powder after |
| Materials | | | 1 week |
| Aramco Performance | Converge CPX- | polyol | not useful |
| Materials | 2012-112 | | |
| Nature Works | Ingeo Biolpolymer | polylactic acid, | one day |
| | DH6050 | polyester | (absorbs |
| | | | water) |

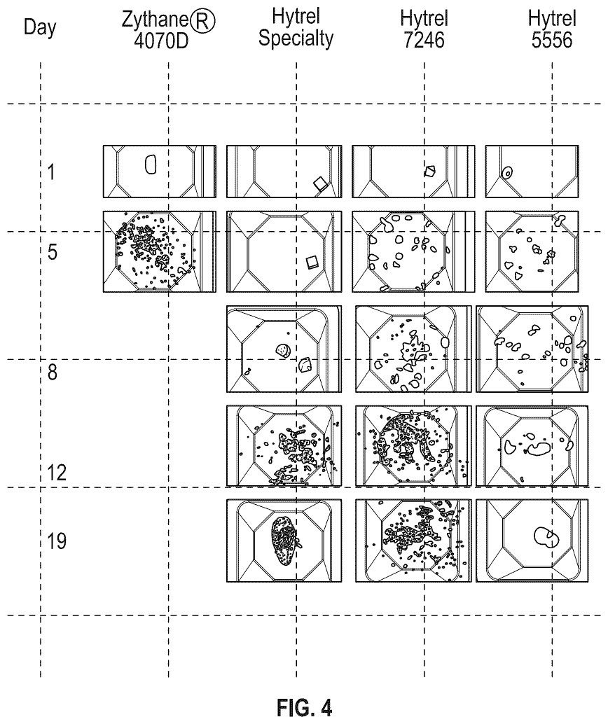

FIG. 4 provides a representative example of the physical changes upon hydrolysis of the polymer samples from DuPont (Hytrel® 7246) and APS Elastomers (Zythane 4070D). The elastic polymer beads of these polymers become rigid and fall apart with applied pressure due to the hydrolyzed amorphous phase of the polymer. While all the samples eventually hydrolyze, it can be observed that Hytrel HTR 8801 Specialty and Hytrel 5556 form a paste structure after aging for over 12 days. Formation of such a viscous product upon absorption of the water is undesirable at reservoir conditions and therefore these two samples would not be suitable for applications in accordance with the present disclosure.

The polymer with the fastest degree of hydrolysis was made from polylactic acid (Ingeo Biolpolymer DH6050), while the slowest is the polyamide-based polymer made from Ascend Performance Materials (21ZNT 01A2) with stability in the range of 8-10 days.

TABLE 2
Polymer samples considered to be suitable for further
tests. Table presents with the commercial names as well
as time it takes for sample to hydrolyze (loose viscoelasticity)
when exposed to 150° C. and at least 98% RH.

| | | | Stability | |
|---|---|---|---|---|
| Manufacturer | Trade Name | Type | (days) | Notes |
| APS Elastomers | Zythane ® | polyester TPU | 2 | powder |
| | 4070D | | | |
| DuPont | Hytrel 7246 | PBT TPE | 2 | powder |
| Ascend | 21ZNT 01A2 | Nylons | 8-10 | powder |
| Performance | | (polyamides) | | |
| Materials | 21 LS | Nylons | 6 | powder |
| | | (polyamides) | | |
| | 50 BW | Nylons | 6 | powder |
| | | (polyamides) | | |
| Nature Works | Ingeo | polylactic acid, | <1 | absorbs |
| | Biolpolymer | polyester | | water |
| | DH6050 | | | |

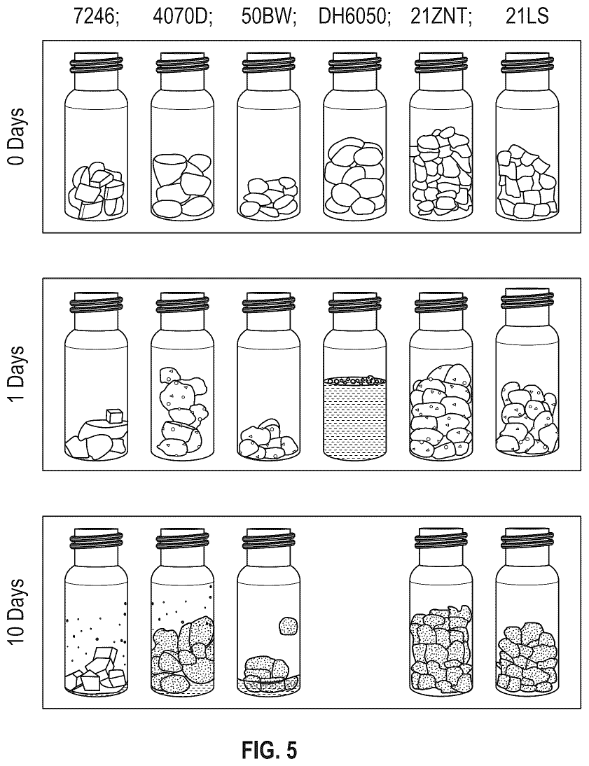

FIG. 5 presents images of the polymer samples from Table 3 before and after exposure to 150° C. and at least 98% RH conditions. It could be observed that degradation of the polylactic acid (Ingeo Biolpolymer DH6050) is accompanied with absorption of the water and dissolution of the polymer residues in the water phase within a day. On the other hand, the rest of the polymer samples remain intact when no external pressure is applied. It can also be noticed that hydrolysis is probably accompanied by oxidation which eventually leads to color change of the samples.

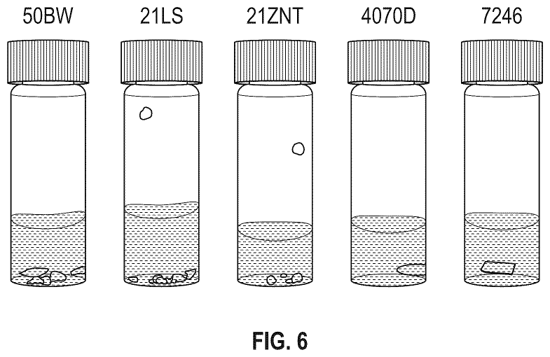

It is important for these polymer samples to hydrolyze into powder, but not into a viscous matter, which eventually can be transported to the surface along with the gas phase. Thus, after hydrothermally treating these samples, except polylactic acid, they were exposed to water and diesel for several weeks at room temperature. Samples in the water phase are presented in FIG. 6 and demonstrate that polyamide samples have fallen apart into smaller particulates while Zythane® 4070D and Hytrel 7246 kept their structural integrity. This experiment suggests that polyamides would decompose and release tracers even if downhole pressure is insufficient to disintegrate them into powder, however; elevated humidity would be essential. Similar samples were also exposed to diesel and no structural changes were observed under analogous conditions.

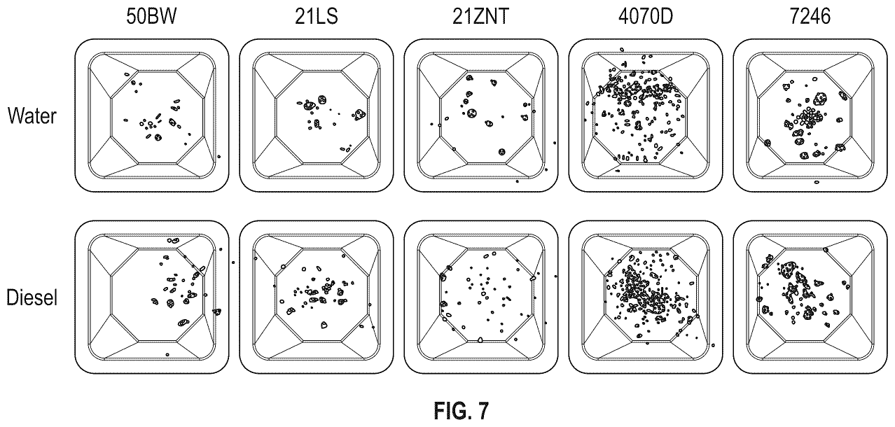

FIG. 7 demonstrates samples which have been exposed to 150° C. with at least 98% RH for 10 days, then separated to water and diesel, respectively. Samples were then exposed to external pressure of at least 10 psi above atmospheric pressure to test their physical properties which resulted in crushing of the samples into powder. This is a desirable physical state where the alternative resulting viscous paste would prevent the matrix from releasing tracers to travel along with the gas phase towards the surface. FIG. 7 demonstrates that these samples do not produce a viscous paste after hydrolysis and thus are good candidates for gas production tracing.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

1. A method for monitoring gas production in a subterranean formation comprising:
introducing at least two polymer composite particles each having a degradable polymer and a tracer into a stimulation fluid, wherein a first degradable polymer of the at least two polymer composite particles is a polyester, polyester copolymer, polyurethane, polyurethane copolymer, polybutylene terephthalate copolymer, or polylactic acid copolymer and a second degradable polymer of the at least two polymer composite particles is a polyamide, and wherein the tracer has an average particle size ranging from 100 nm to 300 microns;
injecting the stimulation fluid comprising the at least two polymer composite particles into the subterranean formation to a treatment stage of a treatment zone comprising at least one opening, wherein the at least two polymer composite particles flow into and remain inside the at least one opening;
maintaining the at least two polymer composite particles inside the at least one opening for an amount of time during which the at least two polymer composite particles are exposed to moisture at a downhole temperature, wherein the moisture degrades the degradable polymer of the at least two polymer composite particles at different rates, thereby releasing the tracer at different times;
recovering produced gas from the subterranean formation, wherein the produced gas comprises a gaseous phase from the treatment stage of the treatment zone of the subterranean formation and the tracer;
determining a presence of the tracer in the produced gas; and
correlating the presence of the tracer to the treatment stage of the treatment zone of the subterranean formation.

2. The method of claim 1, wherein the degradable polymer of the at least two polymer composite particles is a polymer comprising hydrolysable bonds.

3. (canceled)

4. (canceled)

5. The method of claim 1, where the tracer is selected from the group consisting of metals, metal oxides, metal hydroxides, dyes, and combinations thereof.

6. The method of claim 1, where the amount of time is 1 to 10 days.

7. The method of claim 1, wherein the at least two polymer composite particles includes a first polymer composite particle and a second polymer composite particle, wherein the tracer in the first polymer composite particle is released in 1 day.

8. The method of claim 7, wherein the tracer in the second polymer composite particle is released in 8 to 10 days.

9. The method of claim 1, wherein the stimulation fluid is selected from the group consisting of an acidizing fluid, an organic acid, a fracturing fluid, a hydraulic fracturing fluid, an emulsified acid, a viscoelastic surfactant, a foamed fluid, a linear gel, a crosslinked gel, and combinations thereof.

10. The method of claim 1, wherein the at least one opening is a fracture or a wormhole.

11. A composition comprising:
at least two polymer composite particles each comprising:
a degradable polymer; and
a tracer; and
stimulation fluid.

12. The composition of claim 11, wherein the degradable polymer is a polymer comprising hydrolysable bonds.

13. The composition of claim 12, wherein the degradable polymer is different for each of the at least two polymer composite particles.

14. The composition of claim 11, wherein the degradable polymer is selected from the group consisting of polyesters, polyester copolymers, polyamides, polyamide copolymers, polyvinyl alcohols, polyvinyl alcohol derivates, polyurethanes, polyurethane copolymers, polybutylene terephthalate copolymers, polylactic acid copolymers, and combinations thereof.

15. The composition of claim 11, wherein the tracer is selected from the group consisting of metals, metal oxides, metal hydroxides, dyes, and combinations thereof.

16. A method comprising:
dispersing a first tracer in a first degradable polymer matrix to provide a first polymer composite;
dispersing a second tracer in a second degradable polymer matrix to provide a second polymer composite; and
introducing the first and second polymer composites into a stimulation fluid.

17. The method of claim 16, where more than two polymer composites each comprising a different degradable polymer matrix are introduced into the stimulation fluid.

18. The method of claim 16, wherein the first or second degradable polymer matrix comprises a polymer comprising hydrolysable bonds.

19. The method of claim 18, wherein polymer is selected from the group consisting of polyesters, polyester copolymers, polyamides, polyamide copolymers, polyvinyl alcohols, polyvinyl alcohol derivates, polyurethanes, polyurethane copolymers, polybutylene terephthalate copolymers, polylactic acid copolymers, and combinations thereof.

20. The method of claim 16, wherein the first or second tracer is selected from the group consisting of metals, metal oxides, metal hydroxides, dyes, and combinations thereof.
